(19) United States
(12) Patent Application Publication
(10) Pub. No.: US 2011/0285872 A1
(43) Pub. Date: Nov. 24, 2011

(54) RECORDING METHOD

(75) Inventors: Junji SHIOKAWA, Chigasaki (JP); Hiroo Okamoto, Yokohama (JP); Mitsunobu Watanabe, Yokohama (JP)

(73) Assignee: HITACHI CONSUMER ELECTRONICS CO., LTD.

(21) Appl. No.: 13/088,034

(22) Filed: Apr. 15, 2011

(30) Foreign Application Priority Data
May 21, 2010 (JP) 2010-116897

(51) Int. Cl. H04N 5/76

(52) U.S. Cl. 348/231.5; 348/E05.031

(57) ABSTRACT

To provide a recording method for recording still images that is particularly suitable for sorting still images and recording and managing the sorted still images, there is disclosed a recording method for recording still image data and management information for managing the still image data, with the management information including information based on which a plurality of pieces of the still image data are sorted into sorting units, and an earliest one and a latest one of photographing dates at which the pieces of still image data sorted into each of the sorting units are respectively taken.

### CLAIM OF PRIORITY

The present application claims propriety from Japanese Patent Application JP 2010-116897 filed on May 21, 2010, the content of which is hereby incorporated by reference into this application.

### FIELD OF THE INVENTION

The present invention relates to a recording method.

### BACKGROUND OF THE INVENTION

As related art, JP-A-2002-142185 discloses an electronic camera apparatus and a file management method that enhance usability in file management by enabling a user to name a file and a directory as desired while maintaining compatibility with the conventional file management structure pursuant to DCF standards. More specifically, when the electronic camera apparatus is connected with another apparatus that has a recording medium such that data transfer between the apparatuses is possible, and the electronic camera apparatus records image data on the recording medium in a file management structure pursuant to DCF standards, the electronic camera apparatus creates an imaginary directory management file and records the imaginary directory management file on the recording medium so as to enable an integrated management of the image data recorded on the recording medium by means of the imaginary directory management file. The imaginary directory management file associates the actual name pursuant to DCF standards of a directory of the image data recorded on the recording medium, with an imaginary name not pursuant to DCF standards of the directory. The imaginary name of the directory is a name that is used, or associated with the directory, when the directory is recorded.

### SUMMARY OF THE INVENTION

The known technique described above which is for managing sill images is limited in that information that is most useful and wanted when a user views the imaginary directory is not recorded as management information in the imaginary directory.

An object of this invention is to provide a recording method suitable for managing still images. For instance, the invention provides a recording method suitable for managing a large number of still images that are grouped or sorted into a plurality of folders.

To attain the object, the invention provides a method as defined in the appended claims.

The recording method according to the invention is convenient for managing dynamic and still images on a usage-by-usage basis.

Other objects, features, and advantages of the invention will become apparent from the following description of the embodiment(s) of the invention.

### BRIEF DESCRIPTION OF THE DRAWINGS

FIG. 1 is a diagram showing how an AV stream is managed by a recording/reproduction apparatus according to one embodiment of the invention.

FIG. 2 is a diagram showing how an AV stream is managed according to a known method.

FIG. 3 is a block diagram of the recording/reproduction apparatus.

FIG. 4 shows one example of display of original integration information.

FIG. 5 shows a list of playlists as one example of display of user-defined integration information.

FIG. 6 shows display of one example of user-defined integration information.

FIG. 7 shows display of another example of user-defined integration information.

FIG. 8 is a diagram showing one example of a file structure of original integration information, playlist management information, user-defined integration information, playlist information, program information, AV streams (programs) and others.

FIG. 9 shows one example of the structure of a management table of the original integration information.

FIG. 10 shows one example of the structure of playlist management information and the structure of its management table.

FIG. 11 shows one example of the structure of original program management information and its management table.

FIG. 12 shows one example of the structure of user-defined program information and its management table.

FIG. 13 shows one example of the structure of user-defined integration management information and its management table.

FIG. 14 shows a packet structure of an AV stream file.

FIG. 15 shows a processing implemented when an AV stream is divided.

FIG. 16 shows thumbnail management data.

FIG. 17 shows the structure of management information integrating thumbnails and its management table.

FIG. 18 shows contents of a named stream ProgramInfo shown in FIG. 8.

FIG. 19 shows details of ACU information.

FIG. 20 shows the structure of program accompanying information recorded.

FIG. 21 shows a still-image recording structure.

FIG. 22 shows a file structure for sorting recorded still images into sorting folders.

FIG. 23 shows one example of folder management integration information for the sorting of recorded still images.

FIG. 24 shows one example of details of folder management integration information for the sorting of recorded still images.

FIG. 25 shows one example of details of management information for each of the sorting folders.

FIG. 26 is a system block diagram of a camera performing recording and reproduction of a still image.

FIG. 27 is a processing flowchart of a still-image recording/reproduction apparatus.

FIGS. 28A and 28B show one example of display of management information of still images as sorted into sorting folders, and of such still images, respectively.

FIG. 29 is a system block diagram of a camera reproducing a still image.

### DETAILED DESCRIPTION OF THE PREFERRED EMBODIMENTS

Hereinafter, there will be described one embodiment of the invention by referring to the drawings.

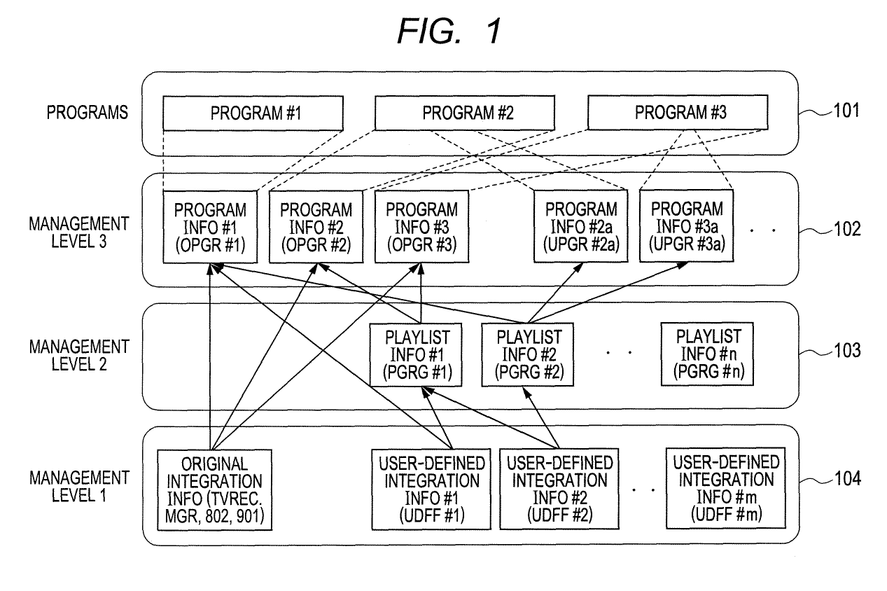

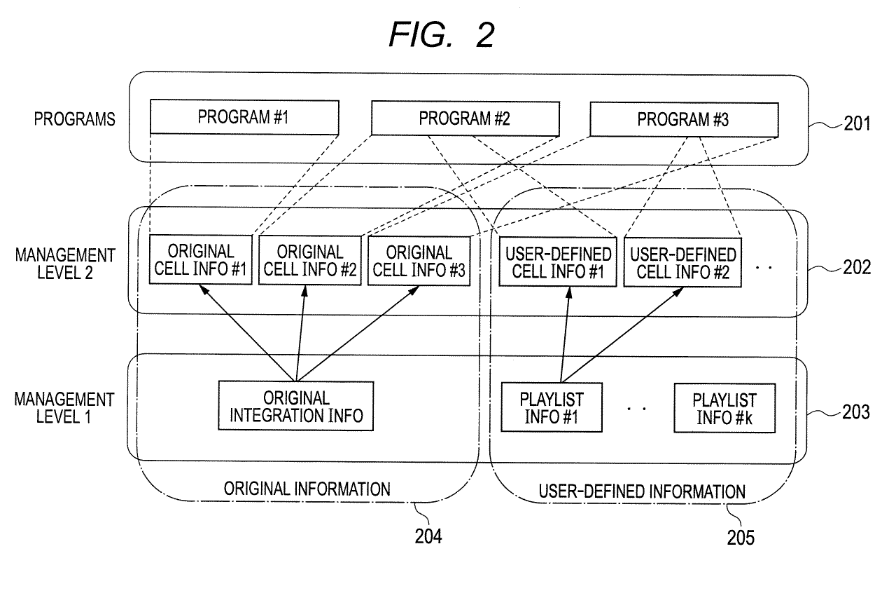

FIG. 1 is a diagram of a hierarchical management structure in which AV streams are recorded and managed on a recording medium in a recording and reproduction apparatus according to an embodiment of the invention. Reference numeral 101 denotes AV streams as recorded on the recording medium in units of programs, which corresponds to 201 in FIG. 2. In this example, three programs #1-#3 are recorded.

Reference numeral 102 denotes a third management level (management level 3) in the management structure, which corresponds to 202 in FIG. 2. Each piece of program information OPGR corresponds to a whole reproduction range of a corresponding one of the programs #1-#3. The program information OPGR #1-#3 making a pair with data of the corresponding program #1-#3 will be hereinafter referred to as “original program information”. Each piece of program information UPGR corresponds to a whole or a part of a reproduction range of a program designated by a user. Such program information will be hereinafter referred to as “user-defined program information” and denoted by UPGR. In the example of FIG. 1, UPGR #2a and UPGR #3a respectively correspond to or represent a part of the program #2 and a part of the program #3. The amount or the number of pieces of the original program information OPGR is increased and decreased in accordance with additional recording and deletion of AV streams, namely, programs. The amount or the number of pieces of the user-defined program information UPGR is increased and decreased in accordance with editing operations by the user.

Reference numeral 103 denotes a second management level (management level 2) in the management structure which corresponds to a management level 1 in FIG. 2. In this example, the management level 2 includes only playlist information #1-#n (PGRG #1-#3). Each piece #1-#n of the playlist information represents an order in which designated ones of the pieces of the program information at the management level 3 are to be reproduced. A plurality of playlists can be retained.

Reference numeral 104 denotes a first management level (management level 1) that is newly added as a feature of the invention to the known management structure. The management level 1 includes a plurality of pieces of integration information including original integration information and user-defined integration information. The original integration information is integration information retaining system resume information and others, and will be described later. Each piece of the user-defined integration information UDFF #1-#m includes a desired one or more of the pieces of the playlist information PGRG at the management level 2 and the pieces of program information OPGR, UPGR at the management level 3. In a case where a plurality of users share a single recording medium, each user creates and uses a piece of user-defined integration information of his/her own, so that the users can individually integrate and manage AV contents that the users desire to reproduce.

Referring to other drawings, the recording and reproduction apparatus of this embodiment will be described in further details.

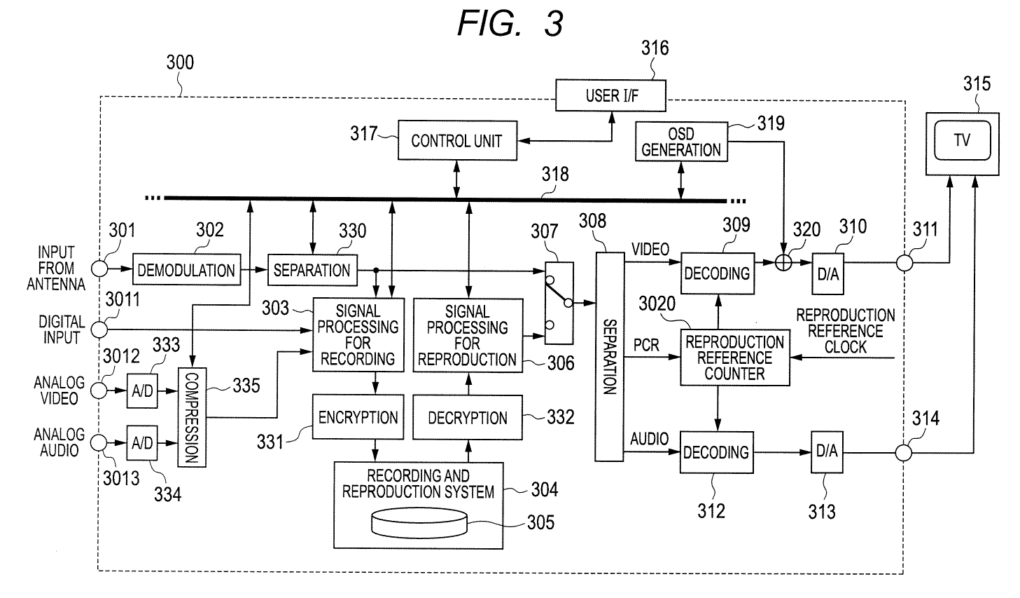

FIG. 3 is a block diagram of the recording and reproduction apparatus of the embodiment, which can receive a digital broadcast program, record the program on a recording medium, reproduce the recorded program, and obtain a reproduction output. Reference numeral 300 denotes the recording and reproduction apparatus, and 301 and 3011 input terminals for receiving a broadcast wave from an antenna and compressed audio/video data from another apparatus, respectively. Reference numerals 3012 and 3013 denote an analog video input terminal for receiving an analog video signal, and an analog audio input terminal for receiving an analog audio signal, respectively. Reference numerals 333 and 334 denote analog/digital converter circuits for converting analog signals into digital signals, 302 and 330 respectively a demodulator circuit and a separator circuit for separating the demodulated digital signal into audio, video, and other data. Reference numerals 335, 303 and 331 respectively denote a compressor circuit for compressing the digitalized video and audio signals, a signal processor circuit for recording, and an encryptor circuit for encrypting data to be recorded. Reference numeral 304 denotes a recording and reproduction system including a function to drive a recording medium, 305 a recording medium, 332 a decryptor circuit for decrypting encrypted data recorded on a recording medium, 306 a signal processor circuit for reproduction, 307 a switch circuit, 308 a separator circuit, 309 a video decoder circuit, 310 a digital/analog (D/A) converter circuit, 311 a video output terminal, 312 an audio decoder circuit, 3020 a reproduction reference counter, 313 a D/A converter circuit, 314 an audio output circuit, 315 a television (TV) set, 316 a user interface (I/F), 317 a control unit, 318 a system bus, 319 an on screen display (OSD) generator, and 320 an adder circuit.

Recording is performed as follows. A signal transmitted from a broadcaster by digital broadcasting or otherwise and received by the recording and reproduction apparatus is demodulated according to a predetermined method by the demodulator circuit 302. The demodulated signal is subjected to necessary signal processing, e.g., addition of data for timing adjustment and modulation, by the signal processor circuit 303 for recording. The processed signal is encrypted by the encryptor circuit 331, and recorded onto the recording medium 305 by the recording and reproduction system 304. A digital signal inputted through the digital input terminal 3011 is subjected to necessary signal processing, e.g., addition of data for timing adjustment and modulation, by the signal processor circuit 303 for recording. The processed signal is encrypted by the encryptor circuit 331, and recorded onto the recording medium 305 by the recording and reproduction system 304. An analog video signal inputted through the analog video input terminal 3012 and an analog audio signal inputted through the analog audio input terminal 3013 are compressed by the compressor circuit 335, and passed to the encryptor circuit 331 to be encrypted thereby, via the signal processor circuit 303 for recording. The encrypted signals are recorded onto the recording medium 305 by the recording and reproduction system 304.

Reproduction is performed as follows. In response to an instruction by the user, digital data is read from the recording medium 305 by the recording and reproduction system 304. When the digital data is encrypted, the data is decrypted by the decryptor circuit 332. When the digital data is not encrypted, the data is passed as-is to the signal processor circuit 306 for reproduction via the decryptor circuit 332. The signal processor circuit 306 for reproduction performs on the data processing necessary for reproduction, e.g., demodulation, and passes the data to the separator circuit 308 via the switch circuit 307. In an instance where the digital data to be reproduced is of an AV stream, the separator circuit 308 passes respective parts of the AV stream to the video decoder circuit 309, the audio decoder circuit 312, and the reproduction reference counter 3020, based on packet IDs (PID defined by MPEG and described later) contained in the AV stream. A value of the program clock reference (PCR defined by MPEG) that first appears in reproducing the AV stream is set at the reproduction reference counter 3020, and thereafter the reproduction reference counter 3020 counts in accordance with a reproduction reference clock in decoding. The video decoder circuit 309 performs a predetermined video decoding processing on the digital data, and the decoded digital data is converted into an analog signal by the D/A converter circuit 310. At the timing when the value of the reproduction reference counter 3020 matches the value of a display time contained in the AV stream of the decoded video signal, the analog signal is outputted to a monitor of the TV set 315 to be displayed thereon, via the video output terminal 311. The audio decoder circuit 312 performs a predetermined audio decoding processing. The digital audio data is converted into the analog audio data by the D/A converter circuit 313, and when the value of the reproduction reference counter 3020 matches the value of a display time contained in the AV stream of the decoded audio signal, the analog data is outputted to an audio output mechanism of the TV set 315 via the audio output terminal 314. Thus, the AV stream is reproduced on the TV set with the video and the audio in synchronization. In an instance where the digital data to be reproduced is of a still image or images that is encrypted, the data is decrypted by the decryptor circuit 332. Where the digital data to be reproduced is of a still image or images not encrypted, the data is read and passed as-is to the video decoder circuit 309 via the decryptor circuit 332, and the video decoder circuit 309 performs a expansion processing according to a predetermined compression method.

The control unit 317 operates to control other functional units of the recording and reproduction apparatus 300 via the system bus 318, and also the general operation of the apparatus to perform an operation based on an instruction inputted by the user through the user I/F 316. A presentation of a request for input of an instruction to the user and a presentation of an OSD display where required by the user are prepared by the OSD generator 319, and added to the output of the video decoder circuit 309 at an appropriate level by the adder circuit 320, and outputted to the monitor of the TV set 315 to be displayed on a screen of the monitor.

As a specific example of usage of the management structure shown in FIG. 1, there will be described an instance where the original and user-defined integration information of the management level 1 is used in presenting the recorded data in the form of display of menus.

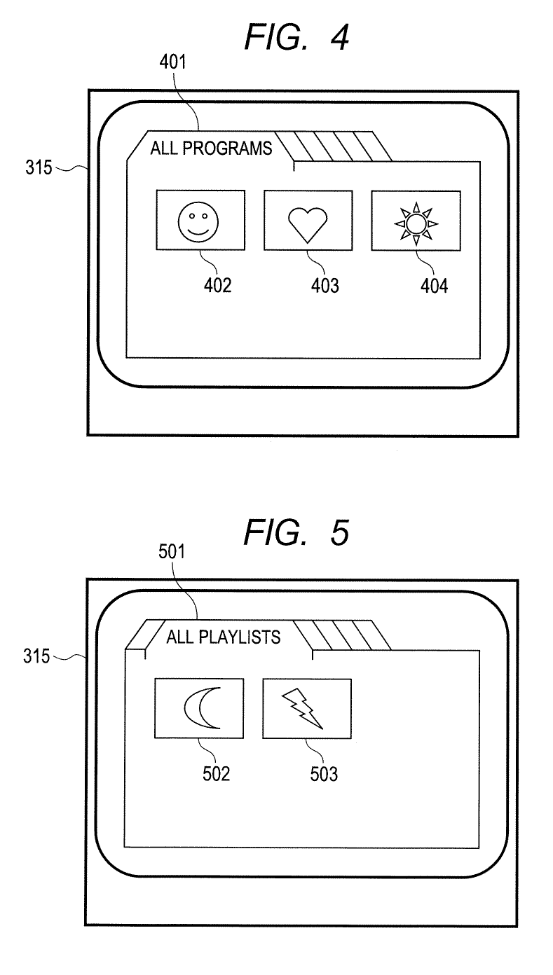

FIG. 4 show one example of presenting the recorded data in the form of display of menus, using the original integration information #1-#m shown in FIG. 1.

In FIG. 4, reference numeral 315 denotes the TV set shown in FIG. 3, 401 a tag for presenting all the recorded programs, and 402, 403, and 404 thumbnails representing the program information #1, #2, and #3, respectively. The user can reproduce a desired one or more or all of the programs by moving a cursor among the thumbnails on the screen and selecting the thumbnails representative of the desired programs, using a remote controller or otherwise.

FIG. 5 shows one example of presenting the recorded data in the form of a menu of playlists, using one of the pieces of the user-defined integration information #1-#m shown in FIG. 1. In FIG. 5, reference numeral 501 denotes a tag for presenting all the stored pieces of playlist information, and reference numerals 502 and 503 denote thumbnails representing the playlist information #1 and #2, respectively. Similar to a manipulation described above with respect to FIG. 4, the user can reproduce a desired one or more or all of the playlists by moving the cursor among the thumbnails and selecting the thumbnail of the desired playlist, using the remote controller or otherwise. To switch the display between that of the tags 401 and 501, the user moves the cursor between portions of the tags where letter strings are put, for instance.

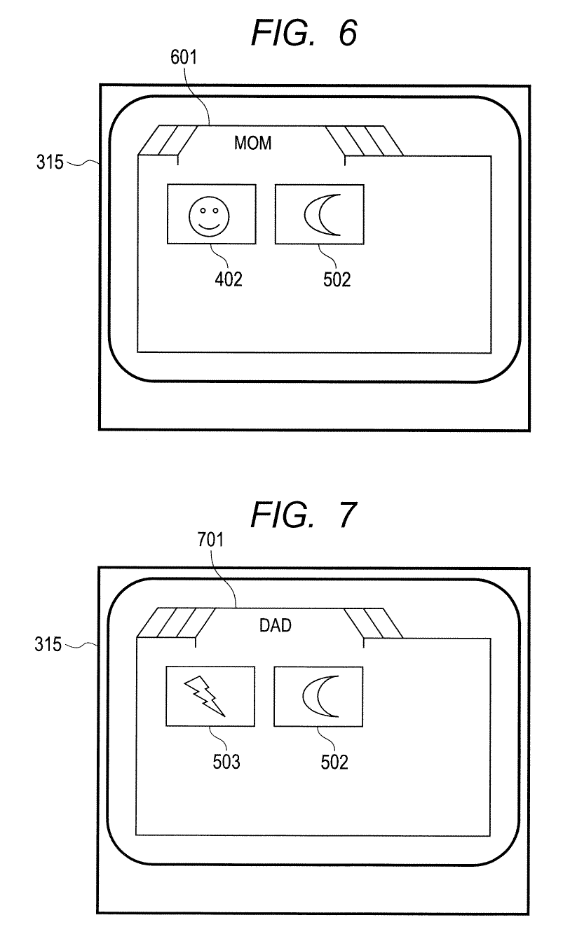

FIG. 6 shows one example of presenting the recorded data in the form of a menu, using the user-defined integration information #1. Reference numeral 601 denotes a tag for presenting a menu for a user #1 who is named “Mom”. Reference numerals 402 and 502 respectively denote thumbnails representing the program information #1 and the playlist information #1 shown in FIGS. 1, 4 and 5. The user “Mom” uses the tag 601 as a folder of its own to which data that the user wants to reproduce can be registered, and from which the thus registered data can be deleted, as desired.

FIG. 7 shows one example of presenting the recorded data in the form of a menu, using the user-defined integration information #2. Reference numeral 701 denotes a tag for presenting a menu for a user #2 who is named “Dad”. Reference numerals 503 and 502 respectively denote thumbnails representing the playlist information #2 and #1 shown in FIGS. 1 and 5. Like the Mom's tag 601, the user Dad uses the tag 701 as a folder of its own to which data that the user Dad wants to reproduce can be registered, and from which the thus registered data can be deleted, as desired. In the Dad's file or tag 701 are selectively registered two playlists, and the user Dad can determine or change the order in which the playlists are reproduced.

According to the present embodiment, all the pieces of playlist information are collectively manageable as a management unit, and the upper management level (management level 1) of the known management structure is restructured such that each piece of the playlist information can handle or aggregate AV stream data in the same units as the original integration information, namely, in units of programs, and a further upper management level is added. The added management level handles integration information defined by users. To each piece of the integration information can be registered a desired one or more of the reproduction ranges defined or retained at the lower management levels (management levels 2 and 3). This enables a user to select a playlist or playlists and/or a reproduction range or ranges to manage, as desired.

Thus, even where a plurality of users share a single recording medium, the users can individually manage favorite contents or contents desired to be reproduced, thereby enhancing the usability of the apparatus.

Although in the above description the case where the digital data received through digital broadcasting is recorded as-is illustrated, application of the embodiment is not limited thereto. For instance, the embodiment is equally applicable to a case where the apparatus has a network interface and an AV stream is received from an external network. Further, the embodiment is applicable to a case where the apparatus has an encoder that encodes analog data while the analog data is being recorded onto the recording medium. That is, the embodiment is relevant to management of data on a recording medium, and the data may be inputted to the apparatus anywise.

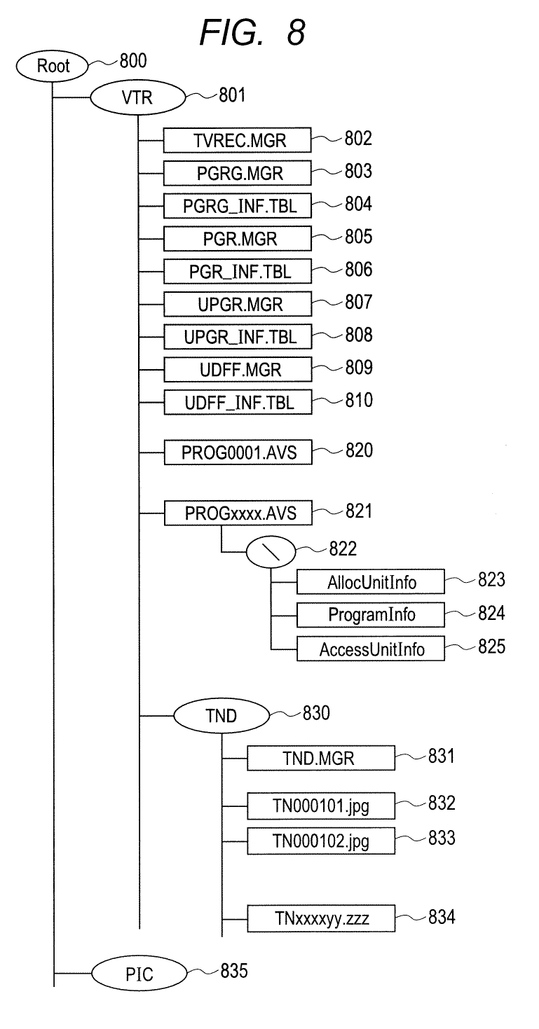

Referring next to FIG. 8, there will be described one example of a file structure in which the programs, the program information, the playlist information, the original integration information, and the user-defined integration information are actually recorded on the recording medium 305 (shown in FIG. 3). The recording medium is a medium on and from which digital data is recorded and reproduced, and files recorded on the medium are managed in a file system similar to that used in managing a recording medium in a personal computer or others. In FIG. 8, a ROOT 800 corresponds to the highest level in a hierarchy of a file directory, and a TVR 801 is located at a hierarchical level below the ROOT 800 and corresponds to a file structure that realizes the management structure shown in FIG. 1. At the hierarchical levels below the TVR 801 are recorded management files such as TVREC.MGR 802, PGRG.MGR 803, PGRG_INF.TBL 804, PGR.MGR 805, PGR_INF.TBL 806, UPGR.MGR 807, UPGR_INF.TBL 808, UDFF.MGR 809, and UDFF_INF.TBL 810, AV stream files PROG0001.AVS 820 and PROGxxxx.AVS 821 where video and audio are multiplexed, and others. A number xxxx between “PROG” and “.AVS” in the file names of the AV stream files is incremented each time a new AV stream is recorded and its file is created and given a name. Reference numeral 830 denotes a directory named TND at a hierarchical level below the directory TVR 801. The directory TND 830 stores files related to thumbnails used in a navigation list and others recorded in the recording medium. Reference numeral 831 denotes a thumbnail management file named TND.MGR that integrally manages actual thumbnail files 832, 833, . . . 834 containing data of thumbnails themselves. As seen of the file 834, each actual thumbnail file is named as TNxxxxyy.zzz, where xxxx corresponds to the number xxxx in the name of one of the program files 820, 821 . . . with which the actual thumbnail file is associated, yy corresponds to no. of an actual thumbnail file that is serially given in an order of registering of the thumbnail files, and zzz represents the kind of the data of the thumbnail, that is, where the kind of the data of the thumbnail is non-compressed bitmap and JPEG (Joint Photographic Experts Group)-compressed, zzz becomes bmp and jpg, respectively. In this embodiment, the actual thumbnail files 832-834 associated with the respectively corresponding program files are recorded individually or discretely, and are not collectively recorded in a single file. This facilitates processing involved when an actual thumbnail file is newly added or is deleted. In particular, in the case of adding and deleting an actual thumbnail file to and from a large-capacity recording medium, e.g., portable hard disk, the required processing time is effectively reduced. Reference numeral 835 denotes a directory named PIC, which stores a management file by which still images are managed, and data of the still images. The directory 835 will be described later.

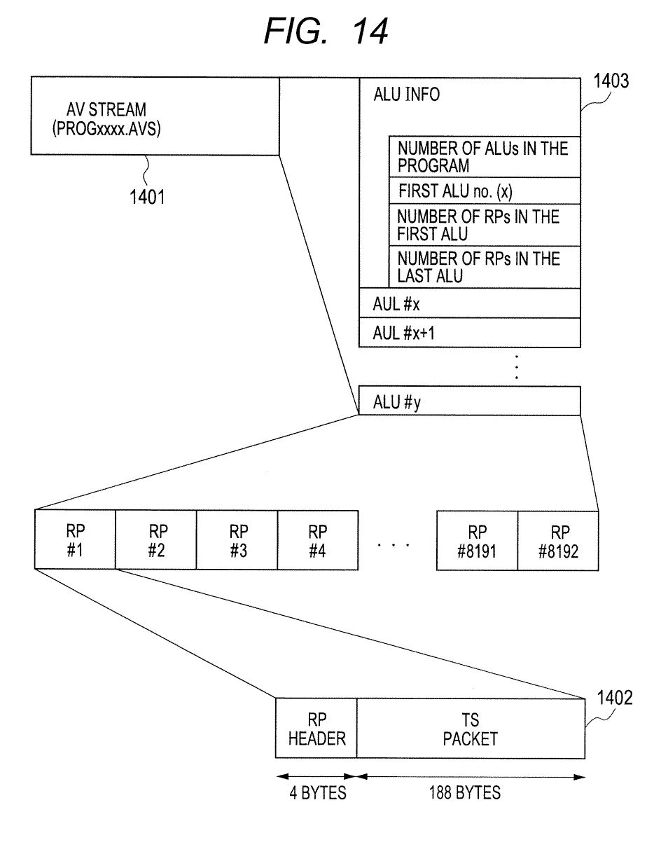

Each of the AV stream files 820, 821 (PROG0001.AVS, PROGxxxx.AVS) shown in FIG. 8 is recorded in a structure shown in FIG. 14.

In FIG. 14, reference numeral 1401 denotes an AV stream file. The AV stream contained in the AV stream file 1401 is received through broadcasting and recorded in units of ALUs. That is, ALUs are minimum units of recording of AV streams. Where the AV stream is encrypted, ALUs are also minimum units of the encryption or decryption. Reference numeral 1402 denotes a recording packet (RP) which is a 192-byte data packet composed of a 188-byte transport packet (TS) as defined by MPEG and a 4-byte (at the time of reception) header of a timestamp representative of the reception time produced by a counter at 27 MHz. In the embodiment, 8192 of the 192-byte RP packets 1402 compose 1 ALU. In the AV stream file 1401 are recorded ALU#x-ALU#y (each composed of 8192 RPs) of the AV stream that are sequentially numbered and recorded, and ALU information 1403 including the total number of the ALUs in the recorded AV stream, no. (x) of the first ALU, the number of RPs in the first ALU (x), and the number of RPs in the last ALU (y) of the AV stream. The ALU information 1403 corresponds to a file AllocUnitInfo 823 shown in FIG. 8. The numbers of RPs in the first and last ALUs of an AV stream may not be 8192 in some cases, and the ALU information 1403 is recorded to represent whether the AV stream is of such a case or not. Detailed description thereof will be provided later.

The AV stream file 820, 821 has a configuration of a stream directory 822 located at a hierarchical level therebelow, for instance in a file structure as defined by Universal Disk Format (UDF), and further has files AllocUnitInfo 823, ProgramInfo 824, and AccessUnitInfo 825 that are called named streams.

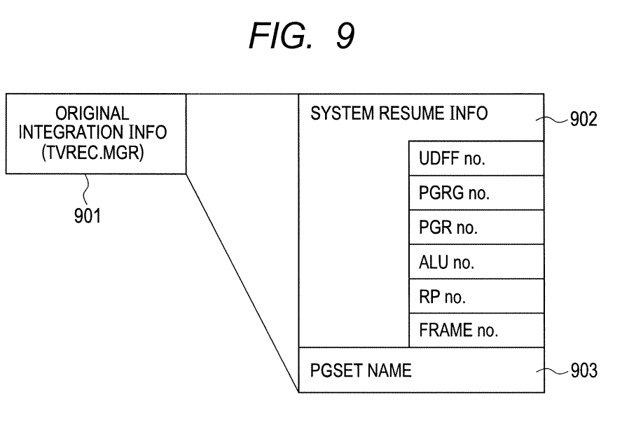

FIG. 9 shows a structure of a management table of the file TVREC.MGR 802 shown in FIG. 8. The file TVREC.MGR 802 records original integration information 901 including system resume information 902 and a PGSET name 903.

As the system resume information is recorded a table containing the following information. That is, no. of a piece of user-defined integration information (UDFF), no. of a piece of playlist information (PGRG) at a management level therebelow, no. of a piece of original or user-defined program information (OPGR or UPGR) at a management level further therebelow, at a point of time when a user has stopped a reproduction, and no. of an ALU (where an ALU is a minimum unit of recording of AV stream, as described later) corresponding to a GOP, RP no. of a recording packet of the GOP in the ALU, and no. of a frame in the GOP, at the same time point. This table enables to control resume of reproduction in units of a frame at the system level. The program number PGR is a hexadecimal number and indicative of whether the piece of program information with the program number is original or user-defined one. For instance, PGR nos. 8000-7FFF indicates that the piece of program information is original, and nos. 8000-FFFF user-defined. Reference numeral 903 denotes a field at which a name (PGSET name) attached to program integration information is recorded. For instance, data of a character string representative of a name that a user gives to the group of contents recorded on the recording medium and being under the management. This can be useful in determining who uses the recording medium, and also facilitates to instantly grasp what the contents group is about by giving a name apparently related thereto.

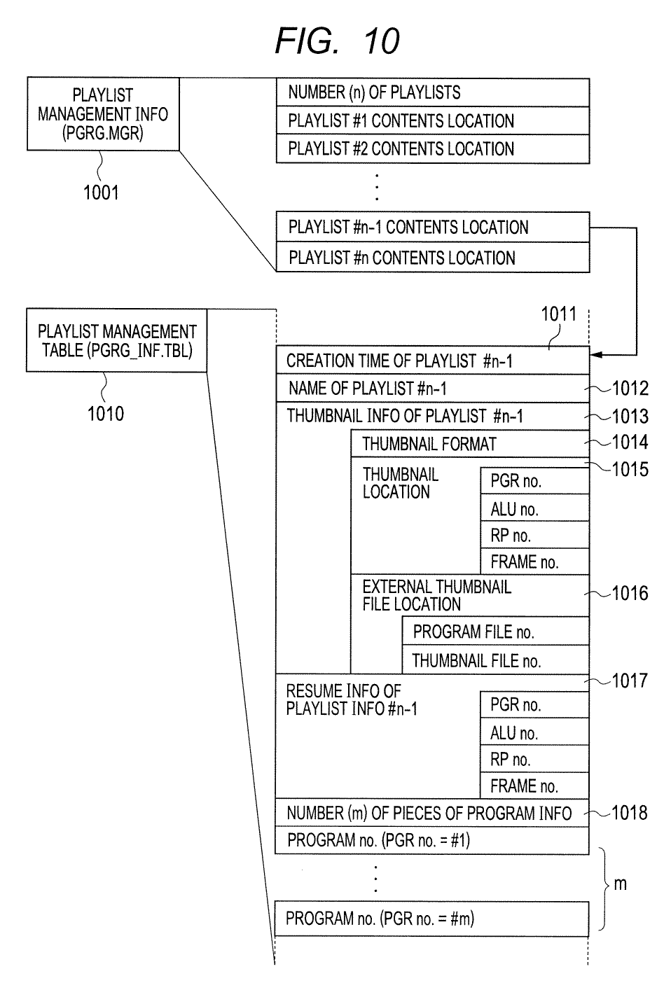

FIG. 10 shows contents of a playlist management information (PGRG) file 1001 and a playlist management table file 1010 by which playlists, namely, information thereof, are managed. The PGRG file 1001 and the playlist management table 1010 respectively correspond to PGRG.MGR 803 and PGRG_INF.TBL 804 in FIG. 8. The PGRG file 1001 records the number of playlists or their pieces of information registered by users, which is n in the specific example of FIG. 10, and information on locations in the playlist management table file 1010 at which contents of the respective playlists #1, #2, . . . #n−1, #n (or their pieces of information) are recorded. For instance, the information on the locations of the playlists may be represented by the numbers of bytes from the top of the playlist management table file 1010 after which the contents of the playlists are respectively recorded.

The playlist management table file 1010 sequentially records the following information of the playlists #1, . . . #n−1, #n or their pieces of information, in the form of a table. A part of the playlist management table 1010 related to the playlist #n−1 will be described to illustrate the structure of the playlist management table 1010. As information on the playlist #n−1, there are recorded the time 1011 (creation time) at which a user has created the playlist #n−1 by manipulating the apparatus, the name 1012 of the playlist #n−1, thumbnail information 1013, resume information 1017, the number 1018 of pieces of original and user-defined program information OPGR, UPGR registered in the playlist #n−1, and a list of nos. of pieces of registered original and user-defined program information (PRG). As described above, the program information number is hexadecimal and indicative of that a piece of program information with no. 7FFF or smaller is OPGR and a piece with no. 8000 or larger UPGR.

Since the creation time 1011 of each playlist is recorded as management information, it is possible to display a list of the playlists that are arranged in an order of creation.

The thumbnail information 1013 shown in FIG. 10 includes format information 1014, location information 1015, and external thumbnail file location 1016. The format information 1014 may include whether content protection is required or not, whether it is necessary to create a thumbnail image to be displayed based on an image at a reference position in the recorded AV streams, and whether thumbnail data registered in an external file is to be referenced. The location information 1015 represents a position in an AV stream (or a PGR corresponding thereto) to be displayed as a thumbnail. More specifically, the location information 1015 includes no. of a piece of program information (PGR) to be displayed as a thumbnail, no. of an ALU corresponding to the location of a GOP to be displayed as a thumbnail in an AV stream corresponding to the PGR no., no. of a RP in the ALU which corresponds to the GOP, and no. of a frame of the GOP to be displayed as a thumbnail.

The resume information 1017 records a point at which reproduction of the playlist #n−1 has been last stopped. More specifically, the resume information 1017 records no. of a piece of program information OPGR (PGR ≦7FFFF) or UPGR (PGR ≧8000) at a point of time when a user has stopped a reproduction of the playlist #n−1, and nos. of an ALU and a RP corresponding to a GOP at the point of time when the reproduction of the playlist #n−1 has been stopped while the program with the number is reproduced, and no. of a frame in the GOP at the same time point. This enables to record and manage resume information 1017 (shown in FIG. 10) for each piece of the original program information or user-defined playlist information, in addition to the system resume information 902 shown in FIG. 9. Thus, at the time of reproduction, there are offered a resume reproduction function to resume at a resume point in each original program, and a reproduction resume control function to control resume with information, such as what number of a program in which piece of user-defined integration information a stop has been made, being referenced, where appropriate, and a user can control reproduction resume precisely in units of a frame.

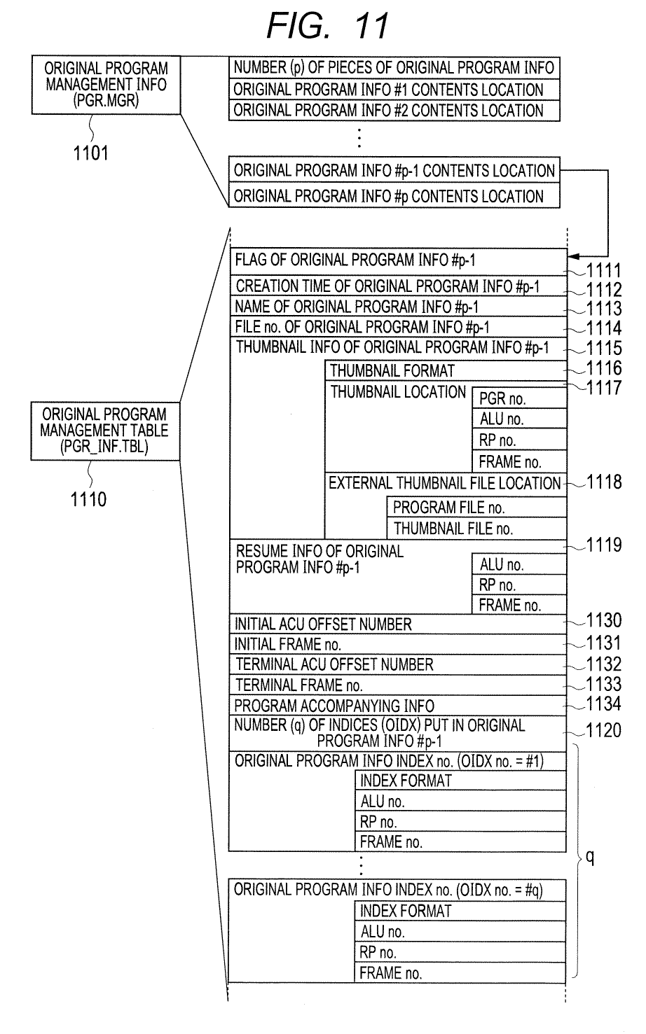

FIG. 11 shows contents of an original program management information (OPGR) file 1101 and an original program management table file 1110. These files 1101, 1110 contain all the pieces of original program information recorded on the recording medium, and a user can reproduce all the AV streams recorded on the recording medium based on the files 1101, 1110. The OPGR file 1101 and the original program management table file 1110 respectively correspond to PGR.MRG 805 and PGR_INF.TBL 806 in FIG. 8. The OPGR file 1101 records the number, which is p in the example of FIG. 11, of original programs, namely, the number of pieces of original program information recorded on the recording medium, and information on locations in the original program management table OPGR_INF.TBL 1110 at which contents of the respective pieces of original program information #1, #2, . . . , #p−1, and #p are recorded. For instance, the information on the locations of the contents of the pieces of original program information may be represented by the numbers of bytes from the top of the original program management table file 1110 after which the contents are respectively recorded.

A part of the original program management table 1110 related to the original program information #p−1 will be described to illustrate the structure of the original program management table 1110. As the original program information #p−1 are contained a program information flag 1111 including information of whether the original program information #p−1 is valid or not and copy control information (CCI), the time (creation time) 1112 at which the original program information #p−1 has been created in response to a manipulation of the apparatus by a user to record the corresponding original program, the name 1113 of the original program information #p−1, the file number 1114 of the original program information #p−1 which corresponds to the part “xxxx” in the file name PROGxxxx.AVS 821 shown in FIG. 8, thumbnail information 1115, resume information 1119, the number of indices 1120, and the format and location of each of the indices. The location of each index is represented by nos. of an ALU and a RP corresponding to a GOP in an AV stream corresponding to the program information #p−1, and no. of a frame designated as the index in the GOP. The term “index” refers to information representative of a position designated or masked by a user through editing of the program corresponding to the original program information #p−1. By thus putting an index in editing of the original program information #p−1, to skip to the position marked with the index and other operations are enabled in units of a frame during or at initiation of reproduction of the program corresponding to the original program information #p−1. Thumbnail information 1115 includes thumbnail format 1116, thumbnail location 1117, and external thumbnail file location 1118, which have the same data structures with the thumbnail format 1014, thumbnail location 1015, and external thumbnail file location 1016 of playlist management table 1010 shown in FIG. 10. The resume information 1119 also has the same structure with the resume information 1017 shown in FIG. 10.

As an initial ACU offset number 1130 shown in FIG. 11 is recorded a difference value between the location of a first GOP in the AV stream of the original program recorded and the location of a reproduction starting GOP from which reproduction of the AV stream is to be started. As an initial frame number 1131, there is recorded no. of a frame which is included in the reproduction starting GOP and from which reproduction of the AV stream is to be started. As a terminal ACU offset number 1132 is recorded a difference value between the location of a last GOP in the AV stream and a reproduction ending GOP to which the AV stream is to be reproduced. As a terminal frame number 1133, there is recorded no. of a frame which is included in the reproduction ending GOP and to which the AV stream is to be reproduced. This prevents reproduction of a portion of the recorded stream at its initial and terminal ends that is unnecessary to reproduce. Further, by defining the difference value between an initial end of the AV stream of the actually recorded original program and a reproduction initial end of the AV stream, and the difference value between a terminal end of the AV stream of the actually recorded original program and a reproduction terminal end of the AV stream, a time gap between an AV stream of the original program as actually recorded and an AV stream of the original program as reproduced can be limited to an amount. For instance, where data of the reproduction range of an AV stream is somewhat destroyed for some reasons, reproduction of the AV stream may become completely impossible, at worst. According to the arrangement where the time gap is limited to an amount, however, the range made unreproducible can be reduced. It is noted that the initial and terminal ACU offset numbers 1130, 1132 may not be difference values, but instead may be nos. themselves of specific ACU entries which designate a range to be reproduced. A definition of the ACU entry number will be described later.

As program accompanying information 1134 in FIG. 11 is recorded accompanying information of the AV stream recorded.

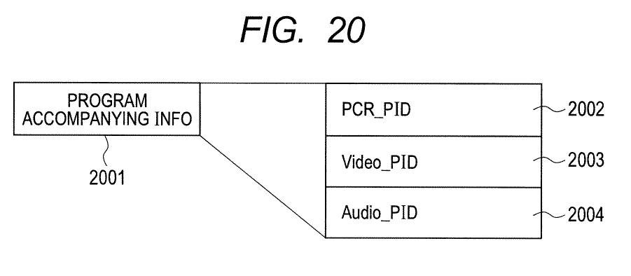

Referring to FIG. 20, there will be described program accompanying information 2001 corresponding to that 1134 in FIG. 11. The program accompanying information includes PCR_PID 2002, Video_PID 2003, and Audio_PID 2004. PCR and PID stand for program clock reference and packet identifier, respectively, as defined by MPEG. As the PCR_PID 2002, there is recorded a PID value of a packet containing a first PCR value in recording of an AV stream. PCR is a reference time in transmitting AV stream.

As Video_PID 2003 in FIG. 20 is recorded a PID value of a packet containing a video elementary stream (ES defined by MPEG).

As Audio_PID 2004 in. FIG. 20 is recorded a PID value of a packet containing an audio ES. In reproducing the AV stream, TS packets are sorted by a separator circuit 308 shown in FIG. 3 to be passed to the decoder circuits, namely, video decoder circuit 309, audio decoder circuit 312, and reproduction reference counter 3020 shown in FIG. 3.

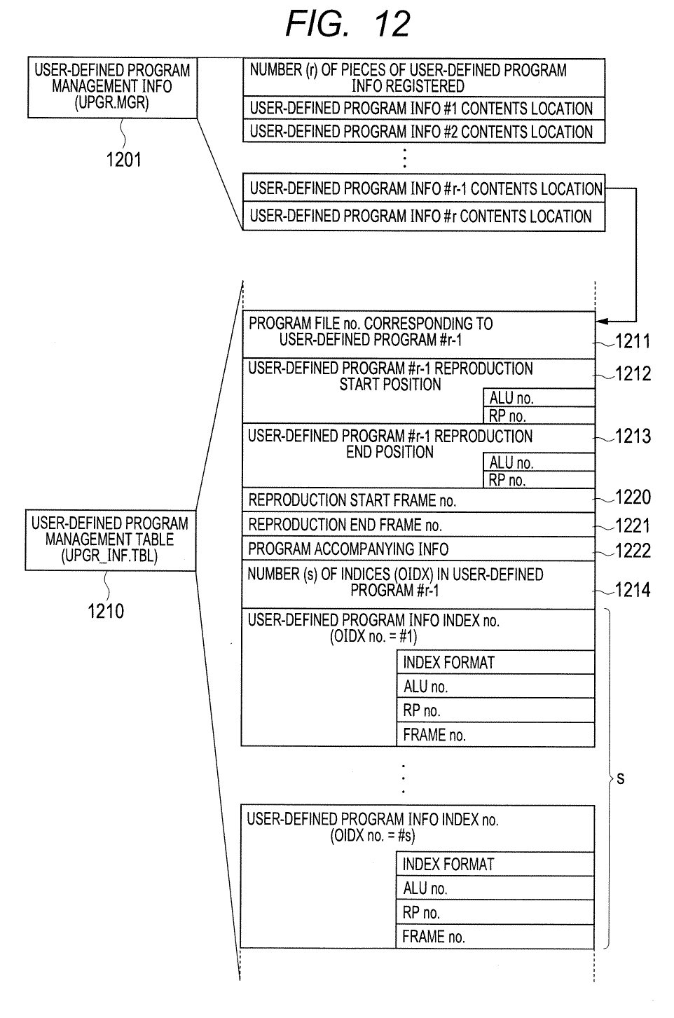

FIG. 12 shows contents of user-defined program management information (UPGR) file 1201 and user-defined program management table 1210, which respectively correspond to UPGR.MGR 807 and UPGR_INF.TBL 808 in FIG. 8. The UPGR file 1201 records the number (which is r in the example of FIG. 12) of user-defined programs that are edited and registered by a user or users, and information on locations in the user-defined program management table at which contents of the respective pieces of the user-defined program information #1, #2, . . . , #r−1, and #r are recorded. For instance, the information on the locations of the contents of the pieces of user-defined program information may be represented by the numbers of bytes from the top of the user-defined program management table file 1210 after which the contents of the pieces of user-defined program information are respectively recorded.

A part of the user-defined program management table 1210 related to the user-defined program information #r−1 will be described to illustrate the structure of the user-defined program management table 1210. As the user-defined program information #r−1 are contained the file number 1211 of the user-defined program information #r−1 which corresponds to the part “xxxx” in the file name PROGxxxx.AVS 821 shown in FIG. 8, reproduction start position 1212 of an AV stream corresponding to the file number, reproduction end position 1213 of the AV stream, and program accompanying information 1222 as accompanying information in the AV stream recorded. The reproduction start position 1212 includes nos. of an ALU and a RP corresponding to a GOP to be first reproduced in the AV stream, and no. of a frame 1220 in the GOP from which reproduction is to be initiated. The reproduction end position 1213 includes nos. of an ALU and a RP corresponding to a GOP to be last reproduced in the AV stream, and no. of a frame 1221 in the GOP at which reproduction is to be terminated. The contents of the program accompanying information 1222 is the same with the program accompanying information 1134, 2001 shown in FIGS. 11 and 20. The user-defined program management table file 1210 further contains the number of indices 1214, and the format and location of each of the indices. The location of each index is represented by no. of an ALU in an AV stream corresponding to the user-defined program information #r−1, and no. of a RP at a position designated as the index in the ALU. Similar to that in the original program information shown in FIG. 11, the index is information representative of a position designated or marked by a user through editing of the program corresponding to the user-defined program information #r−1. By thus putting an index in editing of the user-defined information #r−1, to skip to the position marked with the index and other operations are enabled in units of a frame during or at initiation of reproduction of the program corresponding to the user-defined program information #r−1.

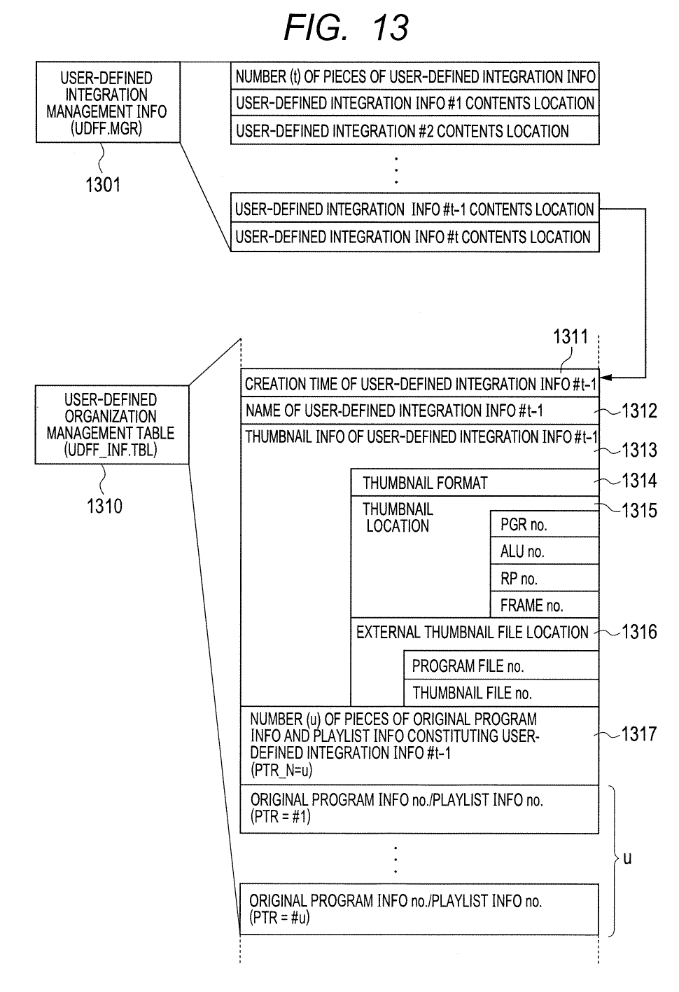

FIG. 13 shows contents of user-defined integration management information (UDFF) file 1301 and user-defined integration management table file 1310, which respectively correspond to UDFF.MGR 809 and UDFF_INF.TBL 810 in FIG. 8. The UDFF file 1301 records the number, which is t in the example of FIG. 13, of pieces of user-defined integration information edited and recorded by a user, and information on locations in the user-defined integration management table UDFF_INF.TBL 1310 at which contents of the respective pieces of user-defined integration information #1, #2, . . . , #t−1, and #t are recorded. For instance, the information on the locations of the contents of the pieces of user-defined integration information may be represented by the numbers of bytes from the top of the user-defined integration management table file 1310 after which the contents are respectively recorded.

A part of the user-defined integration table 1310 related to the user-defined integration information #t−1 will be described to illustrate the structure of the user-defined integration management table 1310. As the user-defined integration information #t−1 are contained the time (creation time) 1311 at which the user-defined integration information #t−1 has been created, the name 1312 of the user-defined integration information #t−1, information 1313 on a thumbnail representative of the user-defined integration information #t−1, the number of original programs and playlists 1317 integrated by the user-defined integration information #t−1 (or the number of numbers of the original programs and playlists), and a list of numbers of the original programs and playlists integrated by the user-defined integration information #t−1.

As the thumbnail information 1313 are recorded thumbnail format 1314, thumbnail location 1315, and external thumbnail file location 1316, which have the same structures with the thumbnail format 1014, thumbnail location 1015, and external thumbnail file location 1016 in the playlist management table 1010 in FIG. 10.

FIG. 16 shows a correlationship between a structure of a thumbnail management data and an external thumbnail file. In FIG. 16, thumbnail management data 1601 includes information on the format of a thumbnail, the location of the thumbnail, and the location of an external file 1603 of the thumbnail. The thumbnail management data 1601 is identical with the thumbnail information 1013, 1115 and 1313 in FIGS. 10, 11 and 13. The thumbnail location is represented by no. of a piece of program information (PGR) of a program file 1602, no. of an ALU corresponding to a position in an AV stream to be displayed as a thumbnail, and no. of a RP in the ALU. The location of the external thumbnail file 1603 is represented by its program file number xxxx and thumbnail file number yy.

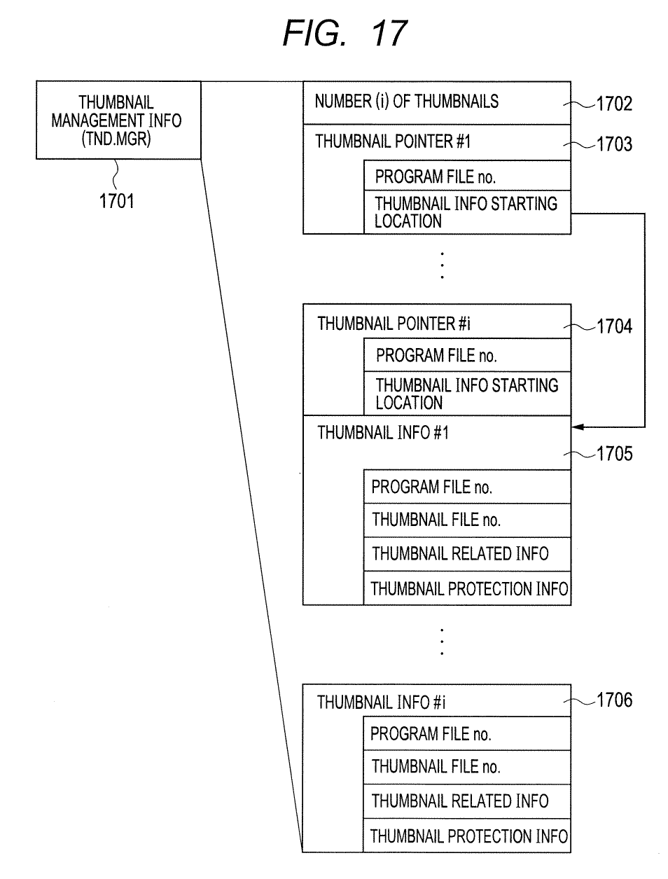

FIG. 17 shows a structure of thumbnail management information file 1701 and corresponds to TND.MGR 831 in FIG. 8. As information integrating the all thumbnails are recorded the number (i in the example of FIG. 17) 1702 of registered thumbnails, thumbnail pointers 1703-1704, and a list of information on the respective thumbnails 1705-1706. The thumbnail pointers 1703-1704 contain information such as pointer values indicative of locations of the information on the respective thumbnails. The thumbnail information 1705-1706 for each thumbnail includes program file no., thumbnail related information, e.g., the vertical and horizontal pixel size of the thumbnail and compression method, and thumbnail protection information, i.e., whether to encrypt the thumbnail or not. By gathering the information on all the thumbnails at a place, namely, at the thumbnail management information file 1701, the information on all the thumbnails can be obtained only by referencing the file 1701. Thus, when a list of the thumbnail information or the like is to be acquired by the apparatus of the embodiment or others, the time required for the acquisition can be reduced.

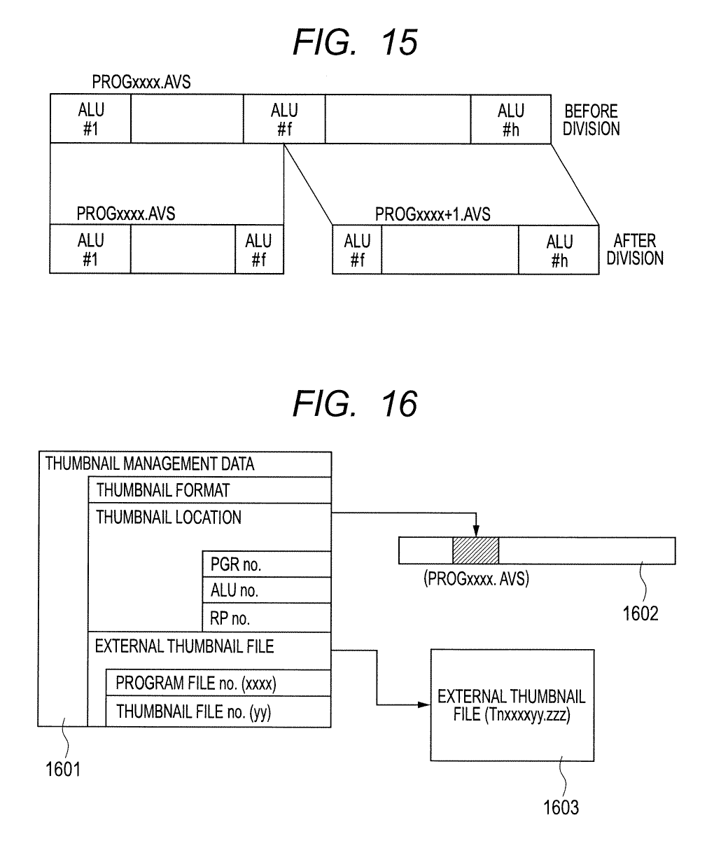

FIG. 15 is a schematic view of how a program file containing an AV stream is managed when a single program is divided by an editing operation by a user, e.g., when a recorded program is divided into two parts. As shown in FIG. 15, an AV stream of a given PROGxxxx.AVS file is a series of ALUs. Thus, it is easy to divide an AV stream in units of an ALU or between two consecutive ALUs. However, since one ALU corresponds to several tens of seconds in reproduction of a recorded AV stream, dividing an AV stream in units of an ALU results in too rough dividing. Hence, it is enabled to divide an AV stream in units of a RP. In an example of FIG. 15, an AV stream PROGxxxx.AVS is divided at an ALU #f . One of two resultant segments of the AV stream PROGxxxx.AVS that corresponds to ALUs #1-#f inherits the name PROGxxxx.AVS. The other resultant segment corresponding to ALUs #f-#h is given a name PROGxxxx+1.AVS, that is, the file no. xxxx is incremented by one, and the thus obtained file is recorded with the new name PROGxxxx+1.AVS. In this instance, the number of RPs in the last ALU of the AV stream PROGxxxx.AVS obtained after the division is not the default number 8192 (see FIG. 14). Hence, the file PROGxxxx.AVS 1401 shown in FIG. 14 is updated such that the parameter “the number of ALUs in the program” in the ALU information 1403 is accordingly changed, and at the same time the parameter “the number of RPs in the last ALU” is also changed to the number thereof after the division, namely, the number of RPs in the ALU #f before a point at which the division is made. As to the AV stream PROGxxxx+1.AVS (shown in FIG. 15) obtained after the division, the ALU information 1403 (shown in FIG. 14) of the AV stream PROGxxxx.AVS as before the division is recorded as ALU information of the AV stream PROGxxxx+1.AVS with the parameter “the number of ALUs in the program” changed and the parameter “the number of RPs in the first ALU” changed to the number of RPs after the division, namely, the number of RPs in the ALU #f after the point at which the division is made. Thus, the precision in the dividing an AV stream is enhanced. In the case where a portion of the AV stream at which division is to be made is MPEG-compressed, dividing in units of a GOP is possible.

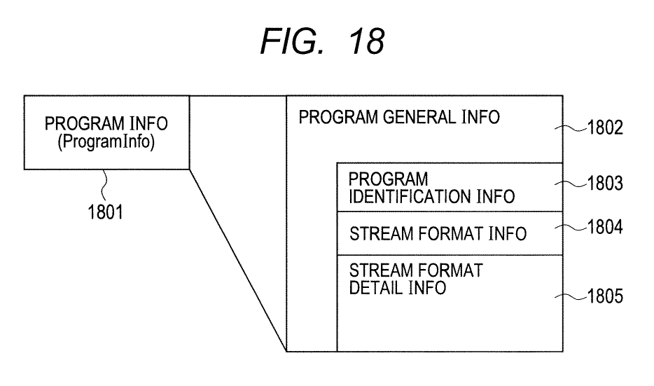

FIG. 18 shows program information 1801, and shows contents of the named stream ProgramInfo 824 shown in FIG. 8. Referring to FIG. 18, as program general information 1002 of an original program of a recorded AV stream are recorded program identification information 1803, stream format information 1804, and stream format detail information 1805. The program identification information 1803 is indicative of that the program is recorded in the recording format according to the present embodiment. The stream format information 1804 is identification information indicative of the kind of the AV stream of the recorded original program, such as of digital broadcast in Japan, Europe, or North America, or self-encoded in a recording apparatus. The stream format detail information 1805 includes the time of initiation and termination of the recording, and the name and genre of the program.

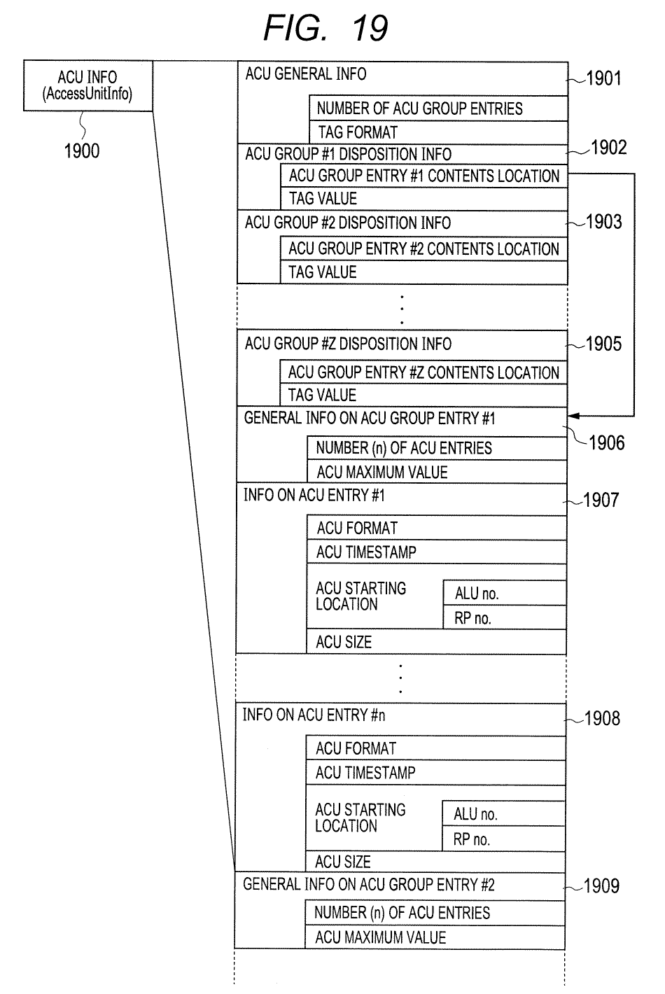

FIG. 19 shows details of ACU information 1900 which corresponds to contents of the named stream AccesUnitInfo 825 in FIG. 8. An ACU has information such as nos. of an ALU and a RP in an AV stream where a GOP is located (FIG. 14), and the number of RPs corresponding to a length of an I picture in the GOP as defined by MPEG. In FIG. 19, ACU general information 1901 retains the number of ACR group entries, i.e., the number of groups of ACUs, and the tag format in the AV stream. Values recorded as the tag format will be described.

For instance, in digital broadcasting in Europe and Japan is used a value called component tag and representative of the kind of stream structure information that is required in reproducing a program supporting she ACU 1900. There is a kind of AV stream called multi-AV stream having a plurality of videos or audios. For instance, an AV stream can have a plurality of videos of a same object taken at various shooting angles. By use of the component tag, it is enabled to superpose, on service information (SI) of a program, information such that the program is a multi-AV stream with a plurality of videos or audios, as the component tag. Further, the component tag can be used in presenting to the user such information in the form of a digital program guide or table. Thus, in digital broadcasting in Europe and Japan, a program with a plurality of streams can be appropriately handled by recording the component tag at the tag format.

However, broadcasting standards in some regions or nations such as the United States of America do not define such a component tag.

Therefore, it is predefined to record a value 00H at the tag format (H is a suffix representative of hexadecimal) in the case of an AV stream recorded with the definition of the component tag, e.g., recorded through digital broadcasting in Europe and Japan, and to record a value 01H at the tag format in the case of an AV stream recorded without the definition of the component tag, e.g., recorded through broadcasting in the United States of America.

By thus configuring a management file, a recording and management method can handle AV streams including information thereon such as whether the component tag is defined or not depending on the broadcast regions of the AV streams.

In this embodiment, a table is used to manage a plurality of groups of ACU entries in the case where a multi-AV stream as described above is recorded, although it is typical that an AV stream has one ACU group. In the table of FIG. 19, following the ACU general information is recorded ACU group #1 disposition information 1902 recording the location of contents of the ACU group entry #1 (for instance, the number of bytes from the top of the ACU information 1900 after which the contents of the ACU group entry #1 is recorded), and the value of the tag value corresponding to the stream of the ACU group entry #1. The ACU group #1 disposition information 1902 is followed by ACU group #2 disposition information 1903, . . . , and ACU group #z disposition information 1905. The tag values in the pieces of the ACU group #1-#z disposition information is a component representing a structure of the AV stream, which may be referred to as component information. In the case where a plurality of screams are included in a program, information on what pieces of ACU group #1-#z disposition information correspond to what AV streams is recorded as the tag values. Following the ACU group #1-#z disposition information 1902-1905, there is recorded general information 1906 on the ACU group entry #1, which includes the total number of recorded ACUs (or the number of ACU entries) in the ACU group entry #1 and a maximum value of the ACUs recorded in the ACU group entry #1. Subsequently, there are recorded pieces of information 1907, . . . , 1908 on respective ACU entries #1-#n, and general information 1909 on the ACU group entry #2, and so on. Each of the pieces of information 1907, 1908 on the ACU entries #1-#n includes the ACU format, ACU timestamp, ACU starting location, and ACU size. The ACU format records, in the form of flags, whether GOP is with sequence header (defined by MPEG) and GOP header, the kind of a picture corresponding to the ACU, i.e., either I or P picture as defined by MPEG, although this embodiment assumes that only I pictures correspond to ACUs. The ACU starting location records no. of an ALU containing the GOP corresponding to the ACU entry no., and no. of a RP corresponding to the ACU entry no. in the ALU. The ACU size records the number of packets of I pictures.

By the ACU information 1900 thus configured, it is enabled, in stream reproduction, to obtain information indicative of the locations of the I pictures in a stream corresponding to the ACU information 1900, and thus to search the stream at high speed to display the I pictures at a given frequency with some of the I pictures skipped. Further, by the value of the component tag, it is enabled in stream reproduction to obtain information on the stream searched at high speed.

In the case where the tag format of the ACU general information 1901 of a recorded stream is not pursuant to the definition of the component tag, namely, where the value of the tag format is 01H or larger, information designated by a program map table (PMT, defined by MPEG) in the AV stream is displayed. More specifically, it is predefined that a tag value n designates an n-th one of the streams listed in the PMT. This enables to record what streams the general information 1906, 1909 on what ACU group entries respectively correspond to, even where the component tag is not defined depending on the broadcast region.

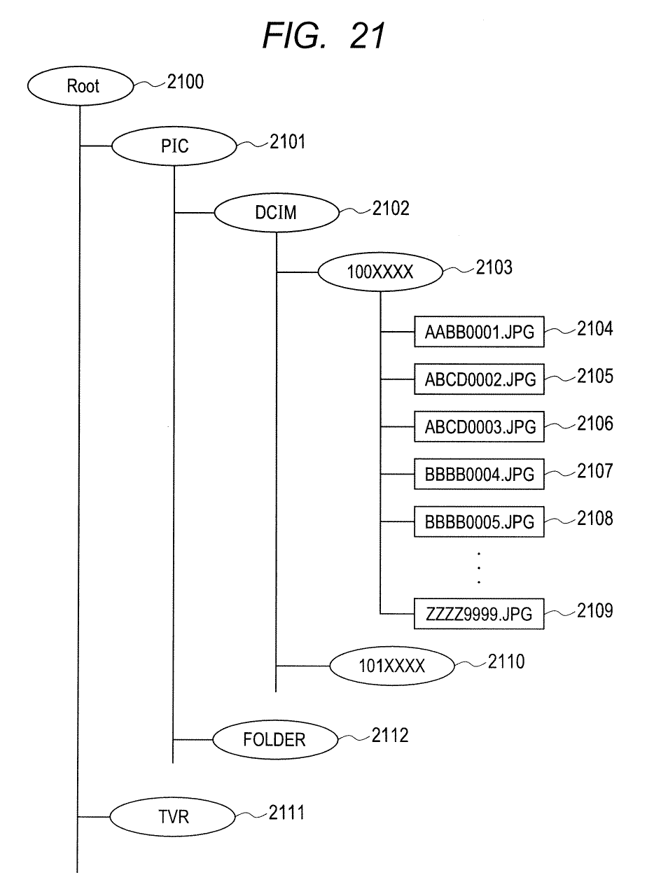

FIG. 21 shows contents of a directory for recording, on a recording medium, data of still images and management information for managing the still image data. In FIG. 21, reference numeral 2100 denotes the highest level or Root in a hierarchy of a file directory. Reference numeral 2101 denotes a directory named PIC at a hierarchical level therebelow, which shows structures of files of the still image data and the management information according to the embodiment. A TVR 2111 is a directory for storing data of dynamic images and a management file for the dynamic image data, and corresponds to the TVR 801 as described above with respect to FIG. 8. In FIG. 21, reference numeral 2102 denotes a directory named DCIM which is pursuant to a format typically used in digital camera and others and created at a hierarchical level below the PIC 2102. At a hierarchical level below the DCIM 2102 is created a directory 2103 with a directory name 100XXXXX. At the part “XXX” in the directory name, five alphabetical letters arbitrarily selected is allocated. The directory 100XXXXX 2103 stores still image data files 2104-2109 with names AABB0001.JPG, ABCD0002.JPG, ABCD0003.JPG, BBBB0004.JPG, BBBB0005.JPG, . . . , ZZZZ9999.JPG, as a hierarchical level created below the directory 100XXXXX 2103. The first half of the file name of the still image data files is a combination of alphabet letters and/or numbers arbitrarily selected. In reproduction processing, discrimination among the files is made by referencing the four digit number 0001-9999 providing the latter half of the file name. In an instance where the file name of the still image data files stored in the directory 2103 goes up to 9999, another directory 2110 is newly created to store additional still image data files to which file names are attached in the same way with the still image data files in the directory 2103. The directory name of the newly created directory 2110 is 101XXXXX, that is, the first three digit number in the directory name is incremented from that of the previously created directory 2103. The file structure shown in FIG. 21 is managed in a file system according to UDF, which is set forth above as one example of file management system, and the directories and files are recorded with attribute information thereof (not shown), namely, times (year, month, day, hour, minute, and second) of creation of the files on the recording medium, as management information of the file system. However, the file structure in FIG. 21 may be managed by other file systems than UDF.

In FIG. 21, reference numeral 2112 denotes a directory with a name FOLDER which realizes a management for organizing into folders the still image data of the directory 2102. There will be described in detail the directory FOLDER 2112.

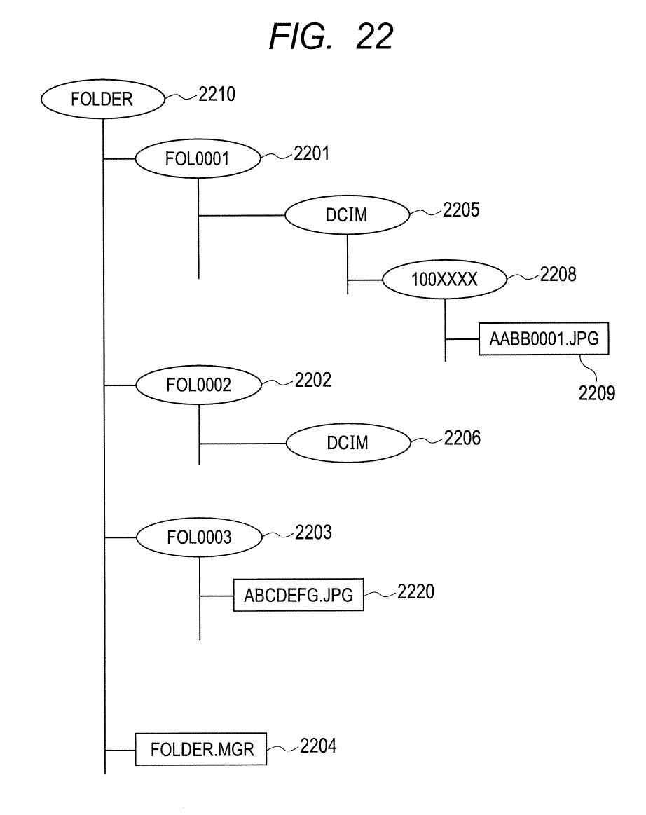

FIG. 22 is a view illustrating sorting folders recorded on the recording medium and its management data that enable a user to manage still image data by grouping or sorting the still image data into folders. In FIG. 22, reference numeral 2210 denotes a directory named FOLDER in which still image data are sorted into folders. The directory FOLDER 2210 stores still image data and a management information file, and corresponds to the directory FOLDER 2112 shown in FIG. 21. In FIG. 22, reference numerals 2201, 2202, and 2203 are directories named FOL0001, FOL0002, and FOL0003, into which the still image data are sorted. At a hierarchical level below the directories 2201-2203 are created directories 2205, 2206 named DCIM. The last four digit number in the directory name of the directories 2201-2203 corresponds to folder number. Reference numeral 2208 denotes a directory named according to the same naming rule with the directory 2103 in FIG. 21, i.e., the name of the directory 2208 is composed of a three digit number and arbitrarily selected five alphabetical letters. Reference numeral 2209 denotes a file of still image data sorted into the file FOL0001 2201. For instance, where the file 2104 (AABB0001.JPG shown in FIG. 21) is sorted into the directory FOL0001 2201 shown in FIG. 22, the file 2104 is recorded as a file AABB0001.JPG 2209 in the directory 100XXXXX 2208 in the directory DCIM 2205. In this instance, the name of the file 2209 may be the same as before the sorting, or may be renamed to another name according to the naming rule, namely, the name is a combination of four arbitrarily selected alphabetical letters and/or numbers and a four digit number. As an instance where a still image data file that is not named in accordance with the naming rule is sorted, there will be described a file 2220 whose name is ABCDEFG.JPG. When such a still image data file ABCDEFG.JPG 2220 is to be sorted into a file and managed, the still image data file ABCDEFG.JPG 2220 is located at a hierarchical level directly below a folder FOL0003 2203 (FIG. 22), without creating DCIM folder at a level below the folder FOL0003 2203. This enables to determine whether or not the sorted file is a still image data file named according to the naming rule like those shown in FIG. 21, and further easily enables to switch the control at the time of reproduction based on the result of the determination. In a case where an initial file structure from which files are to be sorted is that of the DCIM 2102 and the hierarchical levels therebelow, the hierarchical level of the directory 2205, 2206 and the levels therebelow may be configured identically with the initial file structure in order to make it possible to share most part of control logics involved in reproduction among the case of the file structure with the level above the DCIM 2102 and the case of the file structure without such level. Further, when the file structure of the recording medium is viewed on a personal computer, whether specific still image data is data sorted from a typical digital camera or not is easily determinable by simply checking the structure of the contents of the folder into which the still image data is sorted. In FIG. 22, reference numeral 2204 denotes a management file named FOLDER.MGR for managing the directories FOL0001 2201, FOL0002 2202, and FOL0003 2203 hierarchically below the directory FOLDER 2210. There will be described in detail the management file FOLDER.MGR.

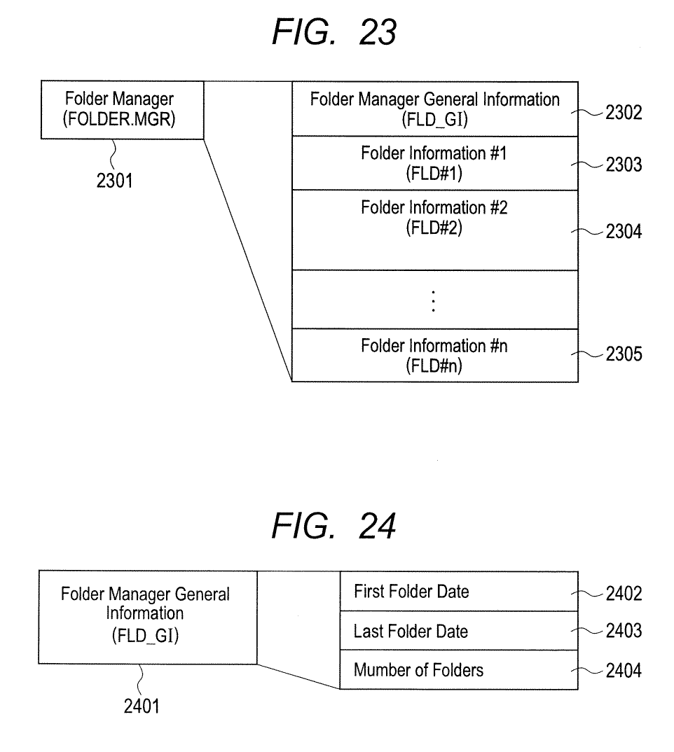

FIG. 23 shows details of the contents of the management file FOLDER.MGR 2204 in the directory FOLDER 2210 shown in FIG. 22. In FIG. 23, reference numeral 2301 denotes the highest level “Folder Manager” in a management structure hierarchy in the management file FOLDER.MGR in FIG. 22. Reference numerals 2302-2305 denote management information at levels therebelow, whose contents will be described. Folder manager general information 2302 records information on creation and updating of the management file 2301 on the recording medium, which will be described in detail later. Folder information #1-#n 2303-2305 records, in one-to-one correspondence, management information on the respective sorting folders created into which the still image data files are sorted. That is, the management information of the respective pieces of folder information #1-#n 2303-2305 are associated with folder nos. of the sorting folders such that the folder information #1 2303 records management information associated with the sorting folder FOL0001 2201 shown in FIG. 22, and the folder information #2 2304 records management information associated with the sorting folder FOL0002 2202 shown in FIG. 22, and so on.

FIG. 24 shows details of the management information (or folder manager general information) 2302 in FIG. 23. Reference numeral 2402 denotes a piece of management information called first folder date, which represents information on the time (e.g., date, hour, minute, and second) when a sorting folder is first created on the recording medium. Reference numeral 2403 denotes another piece of management information called last folder date, which represents information on the time (e.g., date, hour, minute, and second) when a sorting folder is last created on the recording medium. Reference numeral 2404 denotes further another piece of management information that records the number of created sorting folders.

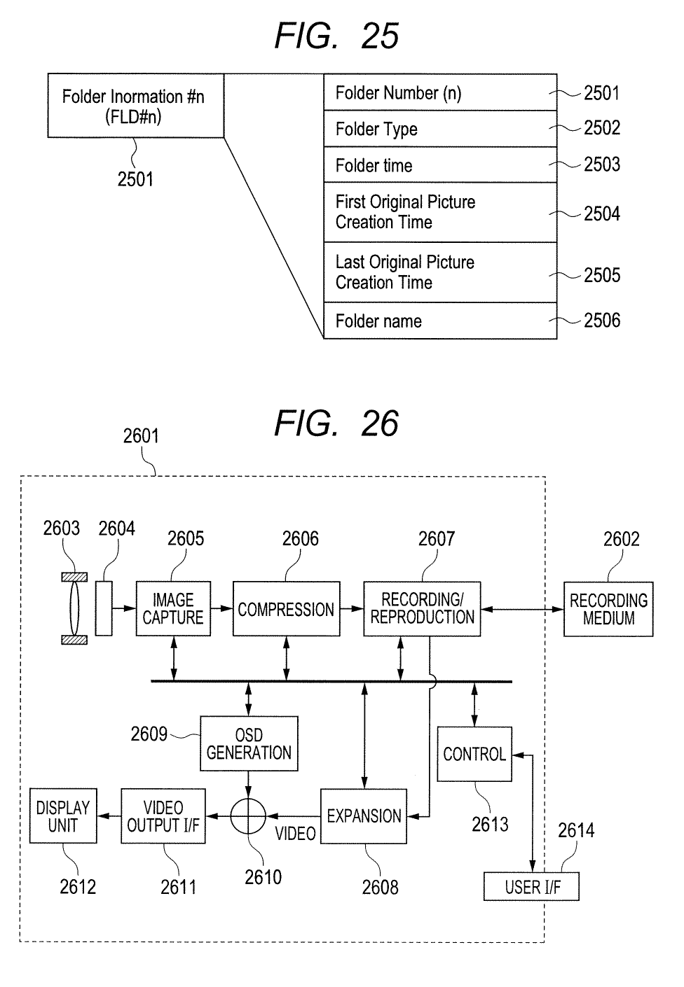

FIG. 25 shows contents of the management information (folder information) 2305 (shown in FIG. 23) of the sorting folder #n. In FIG. 25, folder information #n 2501 corresponds to the management information (folder information) 2305 of the folder #n shown in FIG. 23. Reference numeral 2502 denotes a piece of management information recording folder no. of sorting folder #n. For instance, when the folder information is on the directory FOL0001 2201 representing a sorting file as shown in FIG. 22, the management information 2502 records its folder no. that is 1. Reference numeral 2503 denotes another piece of management information recording folder type, that is, information indicative of whether or not the still image data file or files sorted into the sorting folder is of the typical format of digital camera as described above. In the case of the directories (FOL0001, FOL0002) 2201, 2202 shown in FIG. 22 where sorting of the files is realized by the directories DCIM 2205, 2206 that are of the typical file format of digital camera, the management information 2503 shown in FIG. 25 records a value 1, for instance. On the other hand, in the other cases such as of the directory FOL0003 2203 shown in FIG. 22 where the folder stores a data file that is not of the typical file format of digital camera, the management information 2503 shown in FIG. 25 records a value 0, for instance. According to the embodiment where whether the files are sorted into folders in the typical digital camera format or not is recorded at the management information 2503, it is easy to determine whether or not processings of a control in reproduction is to be based on a file management of the typical digital camera format. For instance, the control may be such that sub-screen information (a thumbnail presentation) of still image data is displayed on the screen, the still images are reproduced one by one in response to an instruction by a user, or the still images are reproduced in the form of a slide show. This makes simple the logics of the control program according to which the reproduction processing is implemented, and also can enhance the processing speed.

As information “folder time” 2504, date, hour, minute, second, and/or others representative of the time at which the directory of the folder #n is created are recorded.

As information “first original picture creation time” 2505 is recorded management information representative of the time (date, hour, minute, and second) at which a still image data file is first sorted into the folder #n. As information “last original picture creation time” 2506 is recorded management information representative of the time (date, hour, minute, and second) at which a still image data file is last sorted into the folder #n. The management information 2505, 2506 is recorded by referencing the attribute information of the sorted still image data files that is managed by the file system, and determining which files are first and last sorted into the folder #n. Thus, for instance, when a period of time at which still images whose data is sorted into the folder #n have been taken is to be displayed on the screen, a presentation processing can be implemented by referencing the management information 2505 and 2506 without involving processings such as that to find the attribute of the still image data files in the folder #n in creating image data of the time period during which the still images have been taken that is to be displayed, thereby reducing the time required to display the time period, for instance. An example of the display of the time period on the screen will be described later.

As information “folder name” 2507 is recorded a name arbitrarily selected and given to the folder #n by a user.

FIG. 26 is a system block diagram of a camera to which the recording method according to the embodiment is applied. In FIG. 26, reference numerals 2601 and 2602 denote a body of the camera and a recording medium, respectively. The recording medium 2602 may be incorporated in the body of the camera, or removable therefrom. Reference numeral 2603 denotes a lens, 2604 an image sensor, 2605 an image processor circuit for converting a signal of a shot image into a video signal, 2606 a compressor circuit for compressing the video signal, 2607 a recording/reproduction unit for recording and reading compressed data on and from the recording medium, 2608 an expander circuit for expanding compressed data into a video signal, 2609 an OSD generator circuit for generating a graphical user interface (GUI) signal, 2610 an adder circuit for adding an OSD signal and the video signal in a specified addition ratio, 2611 a video output I/F, and 2612 a display unit which may be a liquid crystal panel incorporated in the camera 2601 or may be a member separated from the body of the camera 2601, e.g., a part of a TV set. Reference numeral 2614 denotes a user I/F provided by buttons, a touch panel, or a remote controller, for instance. Reference numeral 2613 denotes a control unit integrally controlling the various components of the camera 2601 in response to input through the user I/F unit 2614.

In recording processing, a signal of data taken by the image sensor 2604 through the lens 2603 is converted by the image processor circuit 2605 into a video signal, which is compressed by the compressor circuit 2606. The compressed data is recorded on the recording medium 2602 through the recording/reproduction unit 2607.

In reproduction processing, the compressed data recorded on the recording medium 2602 is read through the recording/reproduction unit 2607, and expanded into a video signal by the expander circuit 2608. The expanded data is added by the adder circuit 2610 to a GUI screen image generated by the OSD generator circuit 2609, in the specified addition ratio. The thus obtained data is presented on the display unit 2612 through the video output I/F 2611. At the time of editing for the sorting the still image data files as described above, a GUI screen image necessary for creating and editing a folder is generated under control of the control unit 2613 in response to input through the user I/F 2614, and the adder circuit 2610 adds the GUI screen image and a predetermined sub screen (thumbnail) of video data in the specified addition ratio. The thus obtained image data is presented as an editing screen on the display unit through the video output I/F 2611. The predetermined sub screen (thumbnail) of video data is obtained via the recording medium 2602, the recording/reproduction unit 2607, and the expander circuit 2608.

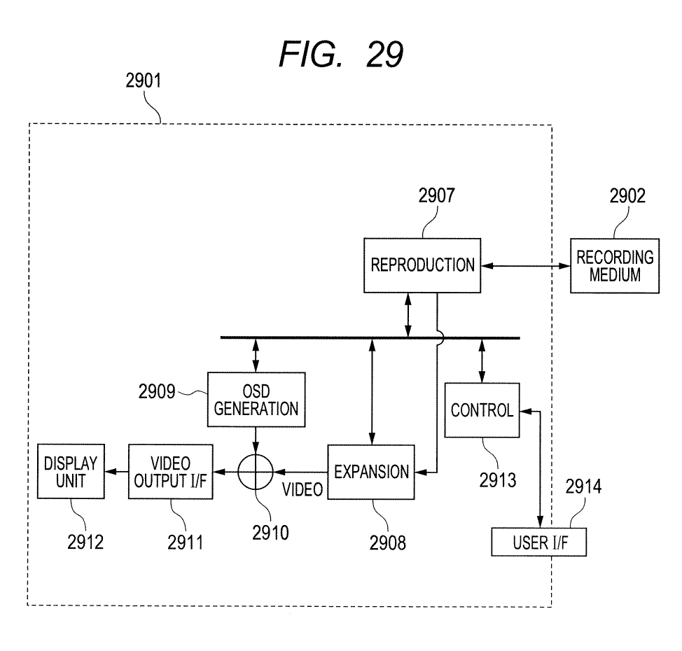

FIG. 29 is a system block diagram of a reproduction apparatus that implements a reproduction processing based on the recording method of the embodiment. In FIG. 29, reference numeral 2901 denotes the reproduction apparatus, 2902 a recording medium, 2907 a reproduction unit for reading compressed data from the recording medium, 2908 an expander circuit for expanding the compressed data into a video signal, 2909 an OSD generator circuit for generating a GUI signal, 2910 an adder circuit for adding the video signal and the OSD signal in a specified addition ratio, 2911 a video output I/F, and 2912 a display unit which may be a liquid crystal panel incorporated in the reproduction apparatus 2901 or may be a member separated from a body of the reproduction apparatus 2901, e.g., a part of a TV set. Reference numeral 2914 denotes a user I/F provided by buttons, a touch panel, or a remote controller, for instance. Reference numeral 2913 denotes a control unit integrally controlling the various components of the reproduction apparatus 2901 in response to input through the user I/F unit 2914.

In reproduction processing, the compressed data recorded on the recording medium 2902 is read through the reproduction unit 2907, and expanded into a video signal by the expander circuit 2908. The expanded data is added by the adder circuit 2910 to a GUI screen image generated by the OSD generator circuit 2909, in the specified addition ratio. The thus obtained data is presented on the display unit 2912 through the video output I/F 2911. At the time of editing for the sorting the still image data files as described above, a GUI screen image necessary for creating and editing a folder is generated under control of the control unit 2913 in response to input through the user I/F 2914, and the adder circuit 2910 adds the GUI screen image and a predetermined sub screen (thumbnail) of video data in the specified addition ratio. The thus obtained image data is presented as an editing screen on the display unit through the video output I/F 2911. The predetermined sub screen (thumbnail) of video data is obtained via the recording medium 2902, the reproduction unit 2907, and the expander circuit 2908.

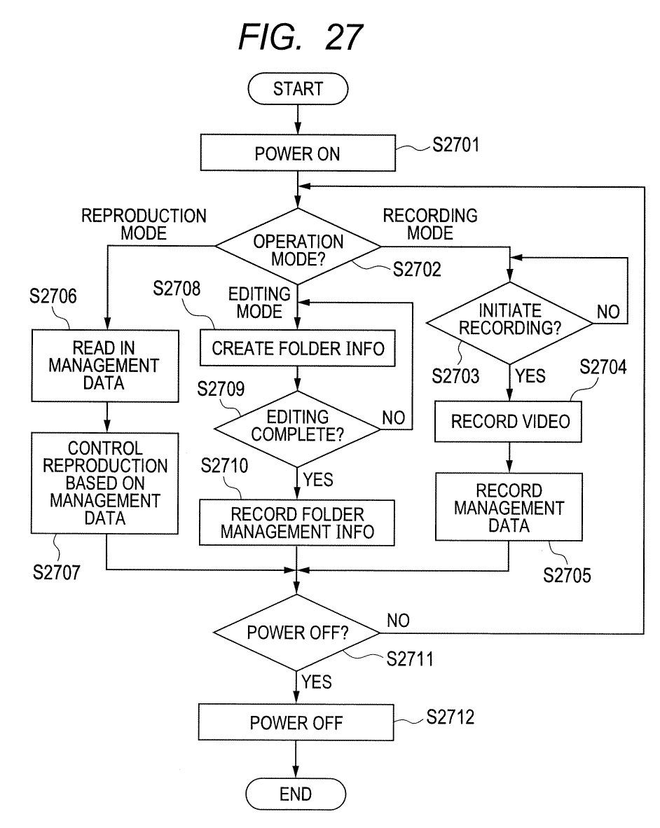

FIG. 27 shows a flowchart illustrating a series of processings including a recording processing implemented when the camera 2601 shown in FIG. 26 performs recording, a reproduction processing implemented when the camera 2601 shown in FIG. 26, the recording/reproduction apparatus 300 shown in FIG. 3, and the reproduction apparatus 2901 shown in FIG. 29 performs reproduction, and a processing to sort still image data files into sorting folders. In FIG. 27, the flow starts with step S2701 at which power of a set is turned on and an initialization processing implemented, and the flow goes to step S2702 to implement an operation mode determination processing in which it is determined based on the state of the user I/F 2614 (FIG. 26) what operation mode is currently selected among “reproduction mode”, “editing mode”, and “recording mode”. When it is determined that the currently selected mode is the recording mode, the flow goes to step S2703 to determined whether recording is to be initiated. When a user presses a recording button in the user I/F 2614 (FIG. 26) or otherwise instructs to initiate recording, the flow goes to step S2704 to implement a recording processing to record video data (which may be either dynamic image data or still image data), and then to step S2705 to implement a management data recording processing to record, on the recording medium, management data of the video data, which includes the file system management information. When it is determined in step S2702 that the currently selected mode is the editing mode, the flow goes to step S2708 to implement a sorting-folder information creation processing in which information on a sorting file and/or a directory is created and/or still image data is moved or copied to a folder, in accordance with input through the user I/F 2613 or 316 (shown in FIG. 26 or 3). The flow then goes to step S2709 to implement an editing termination determination processing in which it is determined based on input through the user I/F 2613 or 316 (FIG. 26 or 3) whether the editing of this cycle is terminated. When it is determined that the editing is terminated, the flow goes to step S2710 to implement a management information recording processing in which the folder management information is recorded and further other information such as the file system management information is recorded on the recording medium. When it is determined in step S2702 that the currently selected mode is the reproduction mode, the flow goes to step S2706 to implement a management information reading processing in which a sorting folder and management data are read in, and then goes to step S2707 to implement based on the management information a reproduction processing in which a processing to display information of the sorting folder and a processing to reproduce still image data in the sorting folder, in accordance with input through the user I/F 2613 or 316 (FIG. 26 or 3). After the series of processings has been implemented, the flow goes to step S2711 to implement a power determination processing in which it is determined based on input through the user I/F 2613 or 316 whether the power is to be turned off or not. When it is determined that the power is not to be turned off, a negative decision (NO) is made and the flow returns to step S2702 to again implement the operation mode determination processing. When it is determined that the power is to be turned off, the flow goes to step S2712 to implement a power-off processing in which a predetermined termination processing is implemented and the processing flow is terminated.

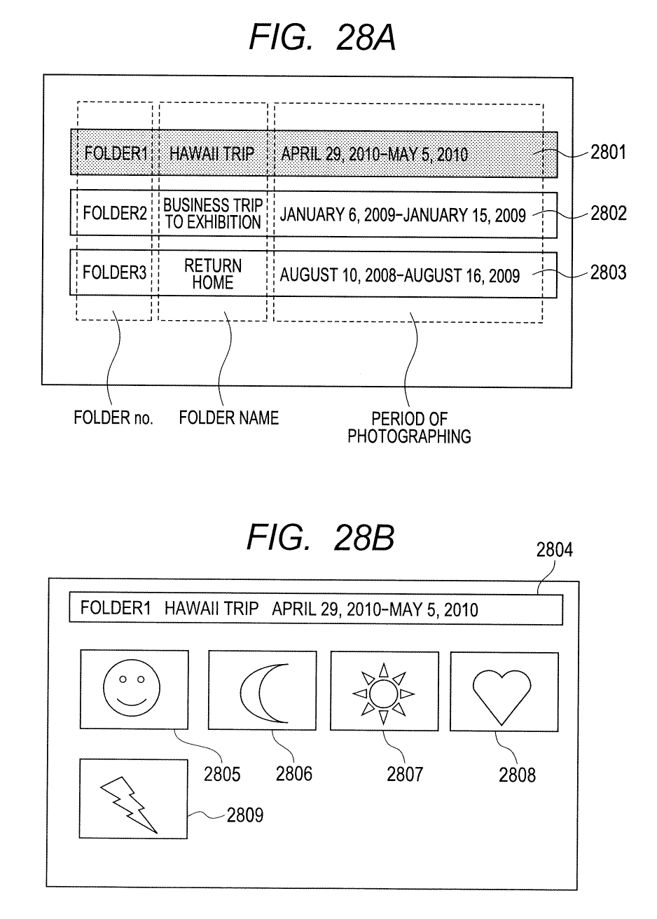

FIGS. 28A and 28B show one example of a GUI display in an instance where reproduction is made by apparatuses such as the recording/reproduction apparatus of FIG. 3, the camera of FIG. 26, and the reproduction apparatus of FIG. 29, in accordance with the still image recording method described above. FIG. 28A shows an example of presentation of a list of sorting folders, which are denoted by reference numerals 2801, 2802, and 2803. The sorting folder 2801 presented with outline characters is a folder being selected. The presentation of the sorting folder 2801-2803 includes folder number, folder name, and period of photographing or shooting, i.e., a period of time during which images whose data files are stored in the folder have been taken. The information necessary for the presenting these kinds of data can be obtained from the management information 2502 (folder number), 2507 (folder name), 2505 (first original picture creation time), and 2506 (last original picture creation time). Hence, in the presentation control, it is unnecessary to implement a processing to read all attributes of the still image data files in the folders to determine folders whose time period of photographing is earliest and latest, respectively, and the speed of the presentation processing can be accordingly enhanced. Further, this configuration is convenient for a user viewing the display of the folders, since the user can see on the screen not only the folder name indicative of the information contents of each folder but also the time period of photographing thereof.

FIG. 28B shows one example of a display of the folder 1 presented after the sorting folder 2801 corresponding to the folder 1 is selected in the list display of FIG. 28A. Reference numeral 2804 denotes a presentation of the folder number, folder name, and period of photographing of the folder 1. Reference numerals 2805-2809 denote a thumbnail presentation of the still image data contained in the selected folder 1. This configuration is convenient for a user viewing the display of the folder 1, since the user can see on the screen not only the folder name indicative of the information contents of each folder but also the time period of photographing thereof.

In an instance where the AV stream (or dynamic image) recording method corresponding to the directory 801 and the levels therebelow, and the still image recording method corresponding to the directory 835 and the levels therebelow, in the management hierarchy shown in FIG. 8, are managed by a single recording medium, the dynamic and still images are manageable on a single recording medium, and recording and reproduction of the dynamic images and that of still images is manageable respectively in their optimal way.

Although one embodiment of the invention has been described above, the invention is not limited thereto but may be embodied with various modifications. For instance, the detailed description of the embodiment is provided for facilitating comprehension of the invention only, and it is not essential that the invention includes all the features illustrated above. Further, an embodiment may include one or more features of another embodiment. Still further, a part of an embodiment may include one or more features of another embodiment, one or more features may be deleted from a part of an embodiment, and a part of an embodiment may be replaced by one or more features of another embodiment.

Further, the features of the embodiment may be provided all by hardware, or alternatively may be realized by execution of a program by a processor. Further, in the drawings are shown only a part of all control lines and information lines that is thought to be necessary for illustration, and not all the control and information lines as in a product. An actual product may be considered to be such that almost all the parts or elements are interconnected.

What is claimed is:

1. A recording method for recording still image data and management information for managing the still image data, the method comprising:
the management information including:
information based on which a plurality of pieces of the still image data are sorted into sorting units; and
an earliest one and a latest one of photographing dates at which the pieces of still image data sorted into each of the sorting units are respectively taken.

2. A recording method for recording still image data and management information for managing the still image data, the method comprising:
a step of recording the still image data;
a step of recording the management information; and
the management information including:
sorting information for sorting a plurality of pieces of the still image data into predetermined sorting units;
information on an earliest one of photographing times at which the pieces of the still image data sorted into each of the sorting units are taken; and
information on a latest one of the photographing times at which the pieces of the still image data sorted into the each sorting unit are taken.
